(19) United States
(12) Patent Application Publication
(10) Pub. No.: US 2008/0033764 A1
(43) Pub. Date: Feb. 7, 2008

(54) Method for Underwriting Claimants

(76) Inventor: Indran Rehan Thurairatnam, New York, NY (US)

Correspondence Address: Indran Thurairatnam, 67 Sullivan St. #A, New York, NY, 10012, US

(21) Appl. No.: 11/681,278

(22) Filed: Mar. 2, 2007

Related U.S. Application Data
(60) Provisional application No. 60/767,085, filed on Mar. 2, 2006.

(51) Int. Cl. G06Q 40/00

(52) U.S. Cl. 705/4

(57) ABSTRACT

This application discloses a new method for underwriting claimants. It is novel in that it is narrowly tailored to combat adverse selection problems such as those that inhere in traditional insurance plans. Whereas the existing method attempts to predict what will cause people to select out of the relevant plans, this method allows adjustment as an option to those interested in selected out through the creation of a new plan with new criteria specified by the party or parties selecting out. This use of the participants to do the underwriting function is also novel.

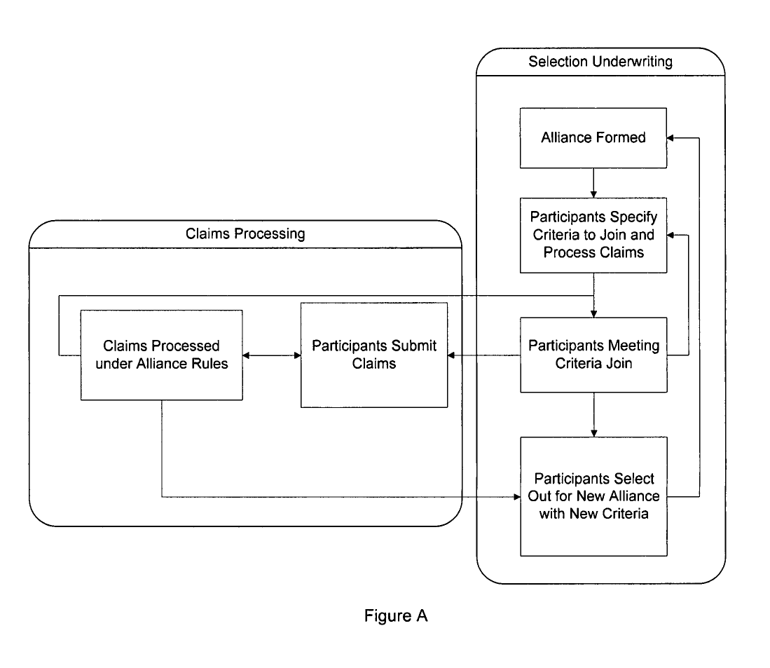

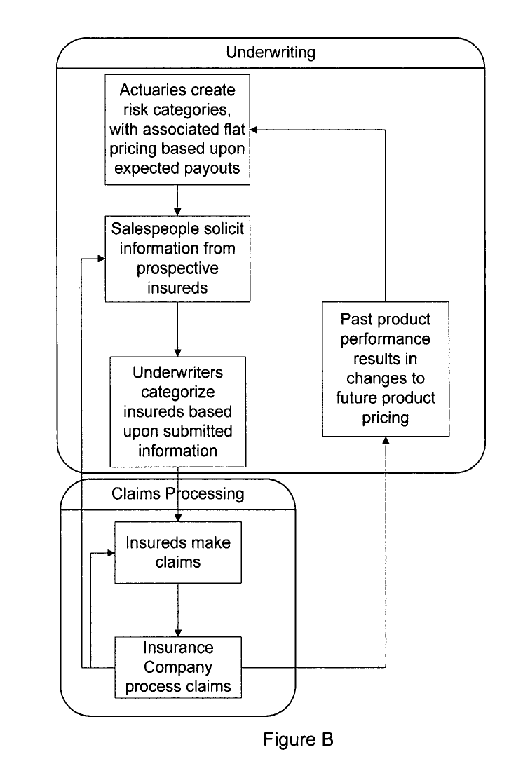

### CROSS-REFERENCES

Method for Processing Claims

Provisional Application 60/767,085

### FIELD OF INVENTION

This invention is directed towards fields where individual entities share their risks in a group plan, such as insurance or pensions. Because each of these individuals has better knowledge about themselves and the risks they face, they will only join the plan if their expected gains from joining are greater than their expected losses plus some premium that they place on the security of the plan. Consequently if there is no discrimination between risk sharers, those parties that believe they face the least risk will opt out of the plan.

The information disparity between the individual and the plan is called an information asymmetry. The process where those facing the least risks select out is called adverse selection, which is a result of mispricing through information asymmetries. The current practice in insurance and pensions is to underwrite participants by gathering information from them and assigning them to categories of participants that face similar risks and thus pay similar premiums.

This invention relates to this process and how to improve the underwriting process by reducing the financial and time costs associated with the process, increasing the availability of risk sharing plans, and potentially increasing the accuracy of categorization.

### Problems Solved

The existing underwriting process suffers in that the plan must predict which factors will cause individuals to select out. Those are the factors that change the amount that individuals are willing to pay to participate, which causes some but not others to price the risk-sharing service differently. However, the process is not narrowly tailored to the problem of individuals selecting out in that because of the need to predict factors and lack of dynamic adjustment of those factors, unnecessary factors will be included and necessary ones will be overlooked: the factors are not included only if necessary and are not omitted if not necessary. These failures result in increased costs overall and lower availability than an underwriting method that is narrowly tailored to the adverse selection problem that inheres in traditional risk-sharing plans.

### Solution Advantages

The method disclosed here for underwriting claims mitigates all of the problems associated with adverse selection. In contrast to the existing method, the disclosed method is narrowly tailored to the problem of adverse selection in that new groups are formed only if the existing group structure induces individuals to select themselves out (unless formed for a reason distinct from adverse selection concerns). Assuming that the individuals do not quit the plan, the converse is true as well: if factors induce individuals to select out of a group, then they will form a new group. As such the method disclosed here is narrowly tailored to the adverse selection problem, which allows for both a lower cost structure and increased risk-sharing availability.

The distributed information gathering method allows information to seep up into the network at very low cost because of the incentives associated with the system. The expected result is more accurate underwriting at lower cost. The distributed nature of the method also allows the incorporation of information that a central system might not be willing to because of external pressures such as political or legal restrictions that do not exist for a distributed system.

### SUMMARY OF ELEMENTS

This new method of underwriting relies upon participants to create their own underwriting criteria and select a claims process in a group process based upon their own knowledge, experience, and biases. This directly addresses adverse selection in that if a criterion is important enough to price people out of the market, rather than select out those people can simply form a new group with or without that screening criterion. As such there are very low costs in getting that information to the market. In addition, information that might never be brought to market in a top down model can easily come to market this way, expanding the group of people that can share their risks effectively.

Once participants select out to form a group, new participants join based upon their traits or claimed traits. They then may submit claims either in accordance with existing practice or otherwise, e.g., as specified in the cross-referenced patent application Method for Processing Claims. Additionally, the members may collectively change the governing underwriting criteria, claims process, and other plan rules as allowed by the rules.

In order to enhance the information available to the participant-underwriters, the groups may require participation for a time in another group that differs from other groups in that the underwriting requirements are fixed, if there are any at all, in order to allow new participants to develop a claims, payment and participation history.

### BRIEF DESCRIPTION OF DRAWINGS

Figure A depicts the elements of the new method including certain optional/variable elements and their interactions.

Figure B depicts the elements and interactions of the existing practice.

### DETAILED DESCRIPTION

This description first describes each of the steps of the process accompanied by a discussion of the best known method for performing each of those steps. Next the description gives the novel features of the invention and the advantages associated with those features.

The process begins an alliance (a group, plan, subgroup or subplan) accepts a prospective future claimant as a participant. It is best to uniquely identify and authenticate parties to prevent parties from joining, quitting, and rejoining without clearing existing balances. The best known method for doing so relies upon standard authentication procedures such as social security numbers, etc. stored in a SQL database on a web server computer to enable remote authentication and joining.

If the participant is a founder of the alliance, then together with the other founding participants she must specify the criteria for joining and those for processing claims. This may be a unanimous agreement, but there also may be consent to use some sort of voting procedure to settle points of disagreement. The best known practice is to store the rules and identities of the members in a SQL database on a web server computer for speedy remote authentication and adding of new members.

After the initial criteria are specified, new people can join the alliance (if new members are allowed) and existing participants may file claims according to the agreed upon governing rules. The best known method is to perform these using a web server: all of the new entries would be added into the existing SQL database structure.

The adverse selection problem is tackled by allowing participants to select out of the plan, this could be allowed at will but subject to their shares of the accrued liabilities of the plan. The best known method of allowing people to select out would be a web implemented process that allows the participant to either select a new alliance to join, quitting then conditional on acceptance into the new alliance or alternatively allow the participant to quit the plan altogether. The web process would update the existing database entries to remove association with the old alliance and to create a new association with the new alliance if the participant so elected.

In addition, the above structure can be combined with an “initial” group that differs from the above groups in that the entry requirements are fixed. It is possible that there may not be any requirements at all such that the group facilitates information development for sorting people into sub-groups that follow the model disclosed above.

Following is a description of how this method as a whole is novel. One novel feature is the feedback mechanism disclosed above whereby the terms of the plan continually adjust in response to new participants (if joining is permitted) and claims and other information and dissenting participants may withdraw to form new groups with different terms. This feedback mechanism is narrowly tailored to combat adverse selection, one of the two fundamental problems with risk-sharing through insurance.

The existing practice in the insurance industry is to minimize the incentive to elect out by categorizing people by their demographics. However, this solution is not narrowly tailored to the problem where there is an information asymmetry between the insurer and the prospective insured such that the underwriter does not take into account information that the prospective insured knows or believes to affect his or her risk profile. Where this is the case some prospective insureds will opt out of the offered plan.

In contrast, the novel mechanism disclosed here is narrowly tailored to combat adverse selection in that people will select out via the disclosed mechanism to found a new alliance only if the associated expected costs are sufficiently off such that the participant wants to quit the plan (ignoring non-economic reasons to select out). Through the alliance founding step, the mechanism then allows the people who selected out to single out what leads them to believe that their future expected costs will be lower than those of the participants of the former plan and form a new alliance based upon those beliefs. Conversely, where the participants have no reason to expect that their expected costs will be lower than those in the plan, they will not select out (ignoring non-economic reasons to select out). Beliefs may be tested empirically by comparing the results to those of other plans if such information is made available. This process is thus narrowly tailored to the adverse selection problem, such that it is more aptly described as a solution to adverse selection rather than a mitigating process: there is no fundamental economic reason why people would want to quit the alliance system. Were it not for transaction costs and information acquisition costs, it could also be said that there is no reason why people would not want to join the alliance system over other risk-sharing plans. Adverse selection is one of the two inherent problems of traditional insurance. The generally noted method of risk-sharing to eliminate adverse selection is self-insurance or non-insurance, the method disclosed here being previously unknown in the art and a significant advance over the alternatives.

Another novel feature is that this process places the onus of categorizing participants on the participants themselves. Consequently, the participants can eliminate the information asymmetries that exist in insurance plans and are able to be eliminated but for political, prudential, legal, or otherwise externally imposed restrictions impeding market functionality. This elimination of some asymmetric information should result in lower costs of risk-sharing and greater availability thereby, as the information asymmetry will inevitably cause insurance to be priced too high or completely unavailable for some.

The intent is for the patent not to restrict the invention to the precise embodiments heretofore described, but to have the patent cover any device or process that falls within the scope of the claims.

What is claimed is:

1. A method for underwriting prospective claimants in order to mitigate adverse selection problems, comprising:
Formation of a new alliance
Specification of the terms for joining, rules for making successful claims, and rules for amending the terms
Prospective participants who meet the specified terms for joining join
Participants elect to amend the rules for joining or the claims process under the existing terms at their discretion pursuant to the rules
Participants submit claims at their discretion pursuant to the rules
Participants may select out of the alliance at their discretion, subject to the liabilities of the alliance at that time pending or accrued or as otherwise specified in the plan terms
Participants who select out may either form a new alliance or simply quit.

2. The method according to claim 1 wherein the participants specify some or all of the initial terms for joining or rules for making successful claims or rules for amending the terms.

3. The method according to claim 1 where some or all of the members spend some amount of time in an alliance without entry requirements or with fixed entry requirements.

4. The method according to claim 3 where participation in the initial alliance is only necessary for participants where no existing alliance or other claims history exists or is accessible.

5. The method according to claim 1 where the process for specification of initial terms or additions to terms is in part or whole selected from a prepared palette of options.

6. The method according to claim 1 when combined with the novel claims process disclosed in the cross-referenced patent application called Method for Processing Claims.

7. The method according to claim 1 where the method is directed towards insurance, pensions, related industries, substitute products, or otherwise relates to the pooling of risk.
